(19) United States
(12) Patent Application Publication
(10) Pub. No.: US 2012/0123614 A1
(43) Pub. Date: May 17, 2012

(54) METHOD AND APPARATUS FOR VIRTUALIZING INDUSTRIAL VEHICLES TO AUTOMATE TASK EXECUTION IN A PHYSICAL ENVIRONMENT

(75) Inventors: MATTHEW EDWIN LAWS, Auckland (NZ); GRANT ANDREW SARGENT, Auckland (NZ); TOBY HARTNOLL JOSHUA COLLETT, Malmo (SE); ANDREW EVAN GRAHAM, Waitakere (NZ); CHRISTOPHER JAMES CHAMBERS, Auckland (NZ); KASHYAP CHANDRASEKAR, Auckland (NZ); CHRISTOPHER W. GOODE, Auckland (NZ); CHEONG HIM LUK, Auckland (NZ)

(73) Assignee: INRO TECHNOLOGIES LIMITED, Auckland (NZ)

(21) Appl. No.: 12/948,358

(22) Filed: Nov. 17, 2010

(51) Int. Cl. G06F 7/00

(52) U.S. Cl. 701/2; 701/50

(57) ABSTRACT

A method and apparatus for virtualizing industrial vehicles to automate task execution in a physical environment is described. In one embodiment, the method includes determining input parameters for controlling vehicle hardware components, wherein the vehicle hardware components comprise actuators that are used to control hardware component operations, generating mappings between the input parameters and the hardware component operations, wherein each of the input parameters is applied to an actuator to perform an corresponding hardware component operation, correlating the mappings with vehicle commands to produce abstraction information and executing at least one task comprising various ones of the vehicle commands using the abstraction information.

### BACKGROUND

1. Technical Field

Embodiments of the present invention generally relate to task automation systems within physical environments and, more particularly, to a method and apparatus for virtualizing industrial vehicles to automate task execution in a physical environment.

2. Description of the Related Art

Entities regularly operate numerous facilities in order to meet supply and/or demand goals. For example, small to large corporations, government organizations and/or the like employ a variety of logistics management and inventory management paradigms to move objects (e.g., raw materials, goods, machines and/or the like) into a variety of physical environments (e.g., warehouses, cold rooms, factories, plants, stores and/or the like). A multinational company may build warehouses in one country to store raw materials for manufacture into goods, which are housed in a warehouse in another country for distribution into local retail markets. The warehouses must be well-organized in order to maintain and/or improve production and sales. If raw materials are not transported to the factory at an optimal rate, fewer goods are manufactured. As a result, revenue is not generated for the unmanufactured goods to counterbalance the costs of the raw materials.

Unfortunately, physical environments, such as warehouses, have several limitations that prevent timely completion of various tasks. These tasks include object handling tasks, such as moving pallets of goods to different locations within a warehouse. For example, most warehouses employ a large number of forklift drivers and forklifts to move objects. In order to increase productivity, these warehouses simply add more forklifts and forklift drivers. Some warehouses utilize equipment for automating these tasks. As an example, these warehouses may employ automated forklifts, to carry objects on paths.

When automating an industrial vehicle, it is first necessary to define motion control over the industrial vehicle. The motion control of the industrial vehicle is unique to that vehicle type. Creating task automation based on the motion control requires the tasks to be customized per the vehicle type. An automation system cannot be migrated from one vehicle to another vehicle without reconfiguration. For example, the automation system cannot use the same vehicle commands on the other vehicle. The automation system must be reprogrammed with details related to operating a different set of hardware components. Furthermore, sensors on each industrial vehicle will be unique to that vehicle type, thus it is difficult for centralized functions, such as path planning, to use sensor data for planning paths around unmapped obstructions.

Therefore, there is a need in the art for an improved method and apparatus for virtualizing industrial vehicles to automate the execution of vehicle-independent tasks in a physical environment.

### SUMMARY

Various embodiments of the present invention generally include a method and apparatus for virtualizing industrial vehicles to automate task execution in a physical environment is described. In one embodiment, the method of virtualizing industrial vehicles to automate task execution in a physical environment includes determining input parameters for controlling vehicle hardware components, wherein the vehicle hardware components comprise actuators that are used to control hardware component operations, generating mappings between the input parameters and the hardware component operations, wherein each of the input parameters is applied to an actuator to perform a corresponding hardware component operation, correlating the mappings with vehicle commands to produce abstraction information and executing at least one task comprising various ones of the vehicle commands using the abstraction information.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a physical environment comprising various embodiments;

FIG. 2 illustrates a perspective view of the forklift for facilitating automation of various tasks within a physical environment according to one or more embodiments;

FIG. 3 is a block diagram of a system for virtualizing industrial vehicles to automate task execution in a physical environment according to one or more embodiments;

FIG. 4 is a functional block diagram of a system for virtualizing a forklift to emulate hardware component operations and enhance safety within an industrial environment according to one or more embodiments;

FIG. 5 is a functional block diagram illustrating a system for optimizing task execution automation using a vehicle characteristics model according to one or more embodiments;

FIG. 6 illustrates a joystick operation emulation circuit according to one or more embodiments;

FIG. 7 illustrates a hydraulic component emulation circuit according to one or more embodiments;

FIG. 8 is a flow diagram of a method for virtualizing industrial vehicles to automate task execution in a physical environment according to one or more embodiments;

FIG. 9 is a flow diagram of a method for calibrating the input parameters based on vehicle responses according to one or more embodiments;

FIG. 10 is a flow diagram of a method for executing a task using the abstraction information according to one or more embodiments; and

FIG. 11 is a flow diagram of a method for converting a task into velocity commands and steering commands according to one or more embodiments.

### DETAILED DESCRIPTION

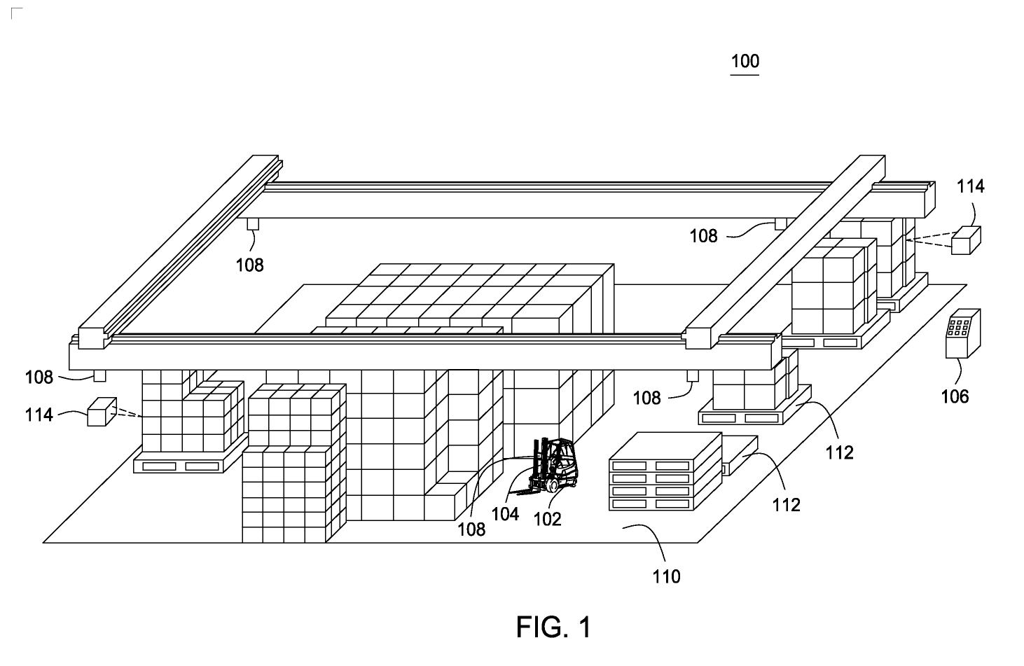

FIG. 1 illustrates a schematic, perspective view of a physical environment 100 comprising one or more embodiments of the present invention.

In some embodiments, the physical environment 100 includes a vehicle 102 that is coupled to a mobile computer 104, a central computer 106 as well as a sensor array 108. The sensor array 108 includes a plurality of devices for analyzing various objects within the physical environment 100 and transmitting data (e.g., image data, video data, range map data, three-dimensional graph data and/or the like) to the mobile computer 104 and/or the central computer 106, as explained further below. The sensor array 108 includes various types of sensors, such as encoders, ultrasonic range finders, laser range finders, pressure transducers and/or the like.

The physical environment 100 further includes a floor 110 supporting a plurality of objects. The plurality of objects include a plurality of pallets 112, a plurality of units 114 and/or the like as explained further below. The physical environment 100 also includes various obstructions (not pictured) to the proper operation of the vehicle 102. Some of the plurality of objects may constitute as obstructions along various paths (e.g., pre-programmed or dynamically computed routes) if such objects disrupt task completion. For example, an obstacle includes a broken pallet at a target destination associated with an object load being transported. The vehicle 102 may be unable to unload the object load unless the broken pallet is removed.

The physical environment 100 may include a warehouse or cold store for housing the plurality of units 114 in preparation for future transportation. Warehouses may include loading docks to load and unload the plurality of units from commercial vehicles, railways, airports and/or seaports. The plurality of units 114 generally include various goods, products and/or raw materials and/or the like. For example, the plurality of units 114 may be consumer goods that are placed on ISO standard pallets and loaded into pallet racks by forklifts to be distributed to retail stores. The vehicle 102 facilitates such a distribution by moving the consumer goods to designated locations where commercial vehicles (e.g., trucks) load and subsequently deliver the consumer goods to one or more target destinations.

According to one or more embodiments, the vehicle 102 may be an automated guided vehicle (AGV), such as an automated forklift, which is configured to handle and/or move the plurality of units 114 about the floor 110. The vehicle 102 utilizes one or more lifting elements, such as forks, to lift one or more units 114 and then, transport these units 114 along a path to be placed at a designated location. Alternatively, the one or more units 114 may be arranged on a pallet 112 of which the vehicle 102 lifts and moves to the designated location.

Each of the plurality of pallets 112 is a flat transport structure that supports goods in a stable fashion while being lifted by the vehicle 102 and/or another jacking device (e.g., a pallet jack and/or a front loader). The pallet 112 is the structural foundation of an object load and permits handling and storage efficiencies. Various ones of the plurality of pallets 112 may be utilized within a rack system (not pictured). Within a typical rack system, gravity rollers or tracks allow one or more units 114 on one or more pallets 112 to flow to the front. The one or more pallets 112 move forward until slowed or stopped by a retarding device, a physical stop or another pallet 112.

In some embodiments, the mobile computer 104 and the central computer 106 are computing devices that control the vehicle 102 and perform various tasks within the physical environment 100. The mobile computer 104 is adapted to couple with the vehicle 102 as illustrated. The mobile computer 104 may also receive and aggregate data (e.g., laser scanner data, image data and/or any other related sensor data) that is transmitted by the sensor array 108. Various software modules within the mobile computer 104 control operation of hardware components associated with the vehicle 102 as explained further below.

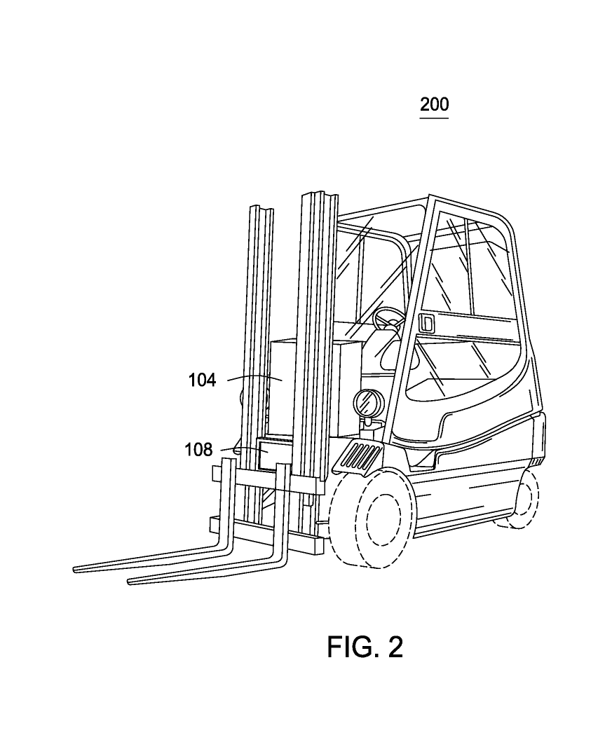

FIG. 2 illustrates a perspective view of the forklift 200 for facilitating automation of various tasks within a physical environment according to one or more embodiments of the present invention.

The forklift 200 (i.e., a lift truck, a high/low, a stacker-truck, trailer loader, sideloader or a fork hoist) is a powered industrial truck having various load capacities and used to lift and transport various objects. In some embodiments, the forklift 200 is configured to move one or more pallets (e.g., the pallets 112 of FIG. 1) of units (e.g., the units 114 of FIG. 1) along paths within the physical environment (e.g., the physical environment 100 of FIG. 1). The paths may be pre-defined or dynamically computed as tasks are received. The forklift 200 may travel inside a storage bay that is multiple pallet positions deep to place or retrieve a pallet. Oftentimes, the forklift 200 is guided into the storage bay and places the pallet on cantilevered arms or rails. Hence, the dimensions of the forklift 200, including overall width and mast width, must be accurate when determining an orientation associated with an object and/or a target destination.

The forklift 200 typically includes two or more forks (i.e., skids or tines) for lifting and carrying units within the physical environment. Alternatively, instead of the two or more forks, the forklift 200 may include one or more metal poles (not pictured) in order to lift certain units (e.g., carpet rolls, metal coils and/or the like). In one embodiment, the forklift 200 includes hydraulics-powered, telescopic forks that permit two or more pallets to be placed behind each other without an aisle between these pallets.

The forklift 200 may further include various mechanical, hydraulic and/or electrically operated actuators according to one or more embodiments. In some embodiments, the forklift 200 includes one or more hydraulic actuator (not labeled) that permit lateral and/or rotational movement of two or more forks. In one embodiment, the forklift 200 includes a hydraulic actuator (not labeled) for moving the forks together and apart. In another embodiment, the forklift 200 includes a mechanical or hydraulic component for squeezing a unit (e.g., barrels, kegs, paper rolls and/or the like) to be transported.

The forklift 200 may be coupled with the mobile computer 104, which includes software modules for operating the forklift 200 in accordance with one or more tasks. The forklift 200 is also coupled with the sensor array 108, which transmits data (e.g., image data, video data, range map data and/or three-dimensional graph data) to the mobile computer 104, which stores the sensor array data according to some embodiments. As described in detail further below, the sensor array 108 includes various devices, such as a laser scanner and a camera, for capturing the sensor array data associated with objects within a physical environment, such as the position of actuators, obstructions, pallets and/or the like.

The laser scanner and the camera may be mounted to the forklift 200 at any exterior position. For example, the camera and the laser scanner may be attached to one or more forks such that image data and/or laser scanner data is captured moving up and down along with the forks. As another example, the camera and the laser scanner may be attached to a stationary position above or below the forks from which the image data and/or the laser scanner data is recorded depicting a view in front of the forklift 200. Any sensor array with a field of view that extends to a direction of motion (travel forwards, backwards, fork motion up/down, and reach out/in) can be used.

In some embodiments, a number of sensor devices (e.g., laser scanners, laser range finders, encoders, pressure transducers and/or the like) as well as their position on the forklift 200 are vehicle dependent. For example, by ensuring that all of the laser scanners are placed at a fixed height, the sensor array 108 may process the laser scan data and transpose it to a center point for the forklift 200. Furthermore, the sensor array 108 may combine multiple laser scans into a single virtual laser scan, which may be used by various software modules to control the forklift 200.

The mobile computer 104 implements a task automation system through which any industrial vehicle may be operated. In one embodiment, tasks for the forklift 200 are automated by emulating at the control-level, actions of a human driver, which include hardware component operation control and environment sensing. The mobile computer 104 implements various forms of control emulation on the forklift 200 including electrical emulation, which is used for joystick and engine controls, hydraulic emulation, which is used where for controlling hydraulic valve operations for vehicle steering, mechanical emulation, which is used where the means of operator actuation is purely mechanical.

Automating hardware operations of an existing industrial vehicle requires at least an actuator and a sensing device together with various software modules for commissioning, tuning and implementing a process loop control. Automating a hardware component operation requires not only control emulation but continuous measurement of the vehicle response. Such measurements may be ascertained directly using installed sensors or indirectly using the native vehicle capabilities. In some embodiments, the automation system also implements direct actuation mechanical component operation emulation where it is required on the industrial vehicle, such as a mechanical parking brake being directly controlled by electrical solenoids or an electrically controlled hydraulic actuator.

As shown further below, vehicle abstraction and modeling reduces the setup and commissioning time for an industrial vehicle to a configuration of attributes that describe vehicle capabilities and characteristics. While core systems for executing vehicle commands and error handling remain unmodified, such attribute configurations enable any vehicle type, regardless of manufacturer or model, to be deployed with little or no knowledge of industrial vehicle specifications and/or skills related to industrial vehicle operation.

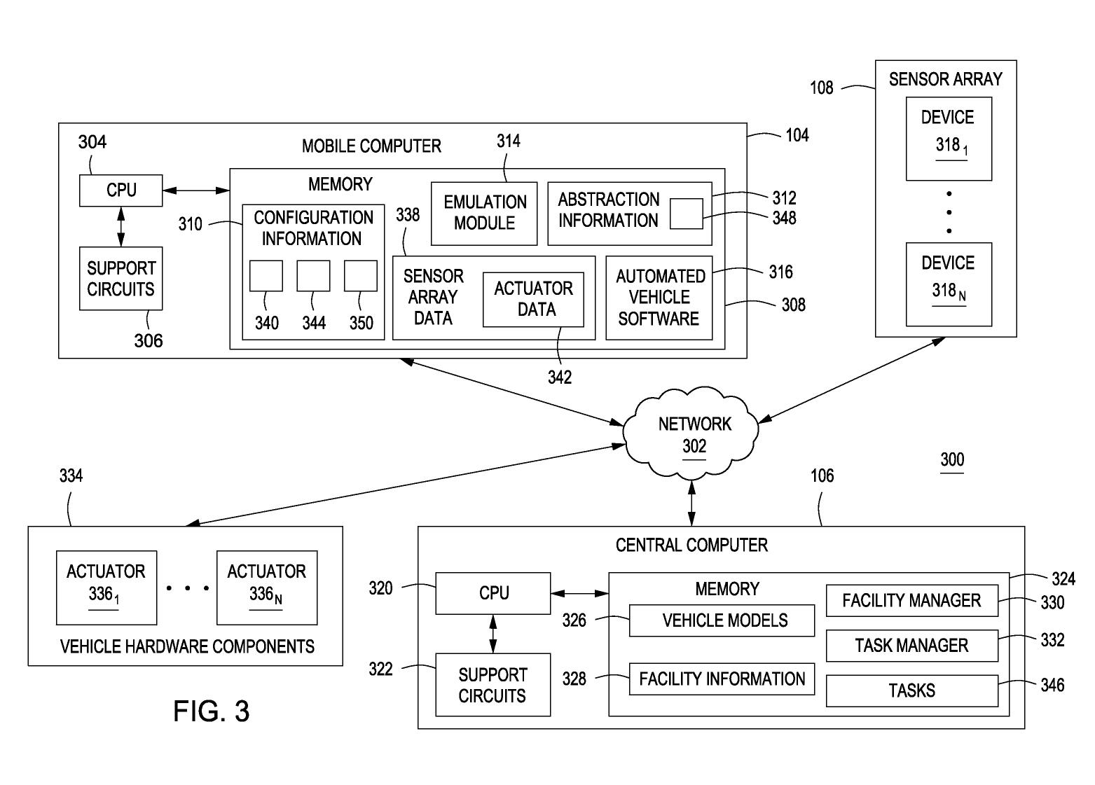

FIG. 3 is a block diagram of a system 300 for virtualizing industrial vehicles to automate task execution in a physical environment according to one or more embodiments. As explained further below, the industrial vehicles are virtualized or modeled as a logical configuration of various vehicle capabilities and vehicle characteristics. In some embodiments, the system 300 includes the mobile computer 104, the central computer 106, the sensor array 108 and vehicle hardware components 334 in which each is coupled to each other through a network 302.

The mobile computer 104 is a type of computing device (e.g., a laptop, a desktop, a Personal Desk Assistant (PDA) and the like) that comprises a central processing unit (CPU) 304, various support circuits 306 and a memory 308. The CPU 304 may comprise one or more commercially available microprocessors or microcontrollers that facilitate data processing and storage. Various support circuits 303 facilitate operation of the CPU 304 and may include clock circuits, buses, power supplies, input/output circuits and/or the like. The memory 308 includes a read only memory, random access memory, disk drive storage, optical storage, removable storage, and the like.

The memory 308 further includes various data, such as configuration information 310, abstraction information 312 and sensor array data 338. The memory 308 includes various software packages, such as automated vehicle software 316 for controlling the movement of an industrial vehicle, for example a forklift, and storing laser scanner data and image data as the sensor array data 338. The sensor array data 338 includes position, velocity and/or acceleration measurements associated with the industrial vehicle movement, which are stored as actuator data 342. The memory 308 also includes an emulation module 314 for generating the configuration information 310 and the abstraction information 312 as explained further below. The automated vehicle software 316 also invokes the emulation module 314 in order to execute vehicle commands 348.

The central computer 106 is a type of computing device (e.g., a laptop computer, a desktop computer, a Personal Desk Assistant (PDA) and the like) that comprises a central processing unit (CPU) 320, various support circuits 322 and a memory 324. The CPU 320 may comprise one or more commercially available microprocessors or microcontrollers that facilitate data processing and storage. Various support circuits 322 facilitate operation of the CPU 320 and may include clock circuits, buses, power supplies, input/output circuits and/or the like. The memory 324 includes a read only memory, random access memory, disk drive storage, optical storage, removable storage, and the like. While FIG. 3 illustrates interaction between the central computer and the mobile computer, it is appreciated that centralized task management is not necessary. In some embodiments, task management is remotely performed at the industrial vehicle.

The memory 324 further includes various data, such as vehicle models 326 and facility information 328. The memory 324 also includes various software packages, such as a facility manager 330 and a task manager 332. The task manager 332 is configured to control the industrial vehicle (e.g., an automated forklift, such as the forklift 200 of FIG. 2) and execute one or more tasks 346. For example, the task manager 332 may generate a path for executing the task 346 and then instruct the automated vehicle software 316 to move at a specific velocity and along the path curvature while engaging and transporting object loads to designated locations.

The network 302 comprises a communication system that connects computers by wire, cable, fiber optic, and/or wireless links facilitated by various types of well-known network elements, such as hubs, switches, routers, and the like. The network 302 may employ various well-known protocols to communicate information amongst the network resources. For example, the network 302 may be part of the Internet or intranet using various communications infrastructure such as Ethernet, WiFi, WiMax, General Packet Radio Service (GPRS), and the like.

The sensor array 108 is communicable coupled to the mobile computer 104, which is attached to an automated forklift (e.g., the forklift 200 of FIG. 2). The sensor array 108 includes a plurality of devices 318 for monitoring a physical environment and capturing data associated with various objects, which is stored by the mobile computer 104 as the sensor array data 338. In some embodiments, the sensor array 108 may include any combination of one or more laser scanners and/or one or more cameras. In some embodiments, the plurality of devices 318 may be mounted to the automated vehicle. For example, a laser scanner and a camera may be attached to a lift carriage at a position above the forks. Alternatively, the laser scanner and the camera may be located below the forks. Furthermore, the laser scanner and the camera may be articulated and moved up and down the automated forklift.

Some of the plurality of devices 318 may also be distributed throughout the physical environment at fixed positions as shown in FIG. 1. These devices 318 indirectly sense and facilitate control over operation of actuators 336. Other devices 318 may be configured to provide a direct measurement of a position of a particular actuator 336 to be controlled. In instances involving motion control when a path is not clear, indirect measurements enable an additional level of control over the industrial vehicle, such as the forklift 200. Another example involves using a low level sensor device (e.g. a laser range finder) to measure fork height. In this example, if the task 346 involves lifting forks above an obstruction, the automated vehicle software 316 uses the low-level sensor device to move the forks to a specific position that a camera or another indirect sensor can determine when the forks are above the obstruction.

In some embodiments, the sensor array data 338 includes an aggregation of data transmitted by the plurality of devices 318. In one embodiment, the one or more cameras transmit image data and/or video data of the physical environment that are relative to a vehicle. In another embodiment, the one or more laser scanners (e.g., three-dimensional laser scanners) analyze objects within the physical environment and capture data relating to various physical attributes, such as size and shape. The captured data can then be compared with three-dimensional object models. The laser scanner creates a point cloud of geometric samples on the surface of the subject. These points can then be used to extrapolate the shape of the subject (i.e., reconstruction). The laser scanners have a cone-shaped field of view. While the cameras record color information associated with object surfaces within each and every field of views, the laser scanners record distance information about these object surfaces. The data produced by the laser scanner indicates a distance to each point on each object surface. Then, these software modules merge the object surfaces to create a complete model of the objects. In another embodiment, the sensor array 108 includes a laser range finder or encoder measures a single attribute such as fork height.

In some embodiments for a retrofit vehicle operation automation system, the mobile computer 104 is configured to couple with an existing industrial vehicle and communicate with the central computer 106. Various software modules within the mobile computer 104 perform one or more tasks 346 as instructed by the various software modules within the central computer 106. In some embodiments, the task manager 332 within the central computer 106 communicates instructions for completing one of the tasks 346 to the automated vehicle software 316, which converts these instructions into the vehicle commands 348.

The vehicle models 326 indicate various physical attributes associated with various types of industrial vehicles according to some embodiments. The facility manager 330 accesses the vehicle models 326 to examine various vehicle capabilities and characteristics as explained further below. A vehicle capabilities model may represent an abstraction of a particular vehicle, such as a forklift, at a highest level. In some embodiments, the vehicle capability model indicates a maximum velocity, lifting attributes (e.g., a capacity, a maximum height and/or the like), types (e.g., narrow aisle, reach, counterbalance and/or the like), mechanical attachments (e.g., barrel clamps and/or the like), fuel attributes (e.g., a type and a capacity) and/or the like.

The configuration information 310 includes mappings between input parameters 340 and hardware component operations 350. In some embodiments, the input parameters 340 refer to input signals (e.g., electrical signals, such as a voltage) that control operation of the actuators 336. The input parameters 340 may include values representing amounts of energy (e.g., volts) that, when applied to the actuators 336, results in movement of the vehicle hardware components 334. In some embodiments, the hardware component operations 350 include various device operations that affect motion control over an industrial vehicle (e.g., the forklift) or a vehicle attachment (e.g., a clamp coupled to the forklift).

In some embodiments, each input parameter 340 may be applied to an associated actuator 334 in order to perform a corresponding hardware component operation 350. Completion of the corresponding hardware component operation 350 results in an expected vehicle response 344. The expected vehicle response 344 may be defined in terms of a particular vehicle command 348. For example, the expected vehicle response 344 indicates a specific velocity and a path to be followed as a result of the corresponding hardware component operation 350. Alternatively, the expected vehicle response 344 may be an aggregated average of positional measurements recorded after multiple performances of the corresponding hardware component operation 350.

In some embodiment, the configuration information 310 may include a voltage profile associated with joystick emulation, which indicates voltages for moving and steering the automated forklift. For example, if a certain voltage is applied to a vehicle control unit which emulates operation of a joystick by a manual operator, an industrial vehicle proceeds to move in an expected direction and at an expected velocity. The configuration information 310 includes a mapping between the certain voltage and the equivalent joystick movement that is necessary for achieving the expected direction and velocity. Deviations from the expected direction and velocity are used to adjust the certain voltage as explained further below.

In some embodiments, the abstraction information 312 indicates compatible hardware component operations 350 for each vehicle command 348. The compatible hardware component operations 350 are used to execute each vehicle command 348. For example, a velocity command may be associated with a joystick operation and/or an engine operation. Similarly, a steering command may be associated with another joystick operation. The steering and velocity commands are vehicle-agnostic while the equivalent joystick operations are vehicle-dependent. Different vehicles use different joystick operations to perform identical steering and velocity commands. For example, a first group of vehicles may use the rear wheels to control steering and movement, while a second group of vehicles use the front wheels. Given the identical steering and velocity commands, the abstraction information 312 includes a joystick operation for moving the rear wheels of the first vehicle group as well as another joystick operation for moving the front wheels of the second vehicle group.

In some embodiments, the emulation module 314 includes software code (e.g., processor-executable instructions) that is stored in the memory 308 and executed by the CPU 304. The emulation module 314 determines input parameters 340 for controlling the actuators 336, such as voltages to vehicle control units, steering wheel or throttle actuators, solenoid valves or coils and/or the like. The actuators 336 are embedded within various hardware components 334. By controlling the input to the actuators 336, the emulation module 314 controls operation of the hardware components 334 (e.g., steering components, engine components, hydraulic lifting components and/or the like). For example, a certain input parameter may refer to a specific voltage (Volts) that is to be applied to an actuator, such as a throttle actuator, to achieve a desired movement such that the industrial vehicle, such as a forklift, moves along a designated path at a particular velocity and direction.

The emulation module 314 examines the sensor array data 338 to identify measurements related to vehicle responses to the input parameters 340. These vehicle responses include vehicle movement and/or hardware component operation, such as lifting element movement. Various sensing devices of the sensor array 108 capture and store various measurements as the sensor array data 338. Based on these measurements, the actuator data 342 indicates position, velocity or acceleration information associated with the vehicle movement during command execution according to some embodiments. The actuator data 342 may further include positional and velocity information associated with the lifting element movement. After the emulation module 314, for example, applies a certain voltage emulating a voltage that a human operator would normally apply and causing the industrial vehicle to move to a new position, the emulation module 314 records the new position as well as velocity and acceleration information in the actuator data 342 along with a time value.

The emulation module 314 may use time and position differences to compute distance and acceleration measurements, which are stored as a portion of measured vehicle responses. Then, the emulation module 314 records a mapping between the certain voltage and any associated movement related to these distance and acceleration measurements according to one or more embodiments. The emulation module 314 also records the velocity, direction and/or the acceleration measurements as the expected vehicle response 344 as explained further below.

If the emulation module 314 applies the certain voltage to the actuator(s) again, the industrial vehicle moves in a direction and velocity that is substantially similar to the expected vehicle response 344 according to some embodiments. In another embodiment, the industrial vehicle moves at a different velocity and/or direction. The emulation module 314 modifies the configuration information 310 in response to the change in velocity and/or direction. By adjusting the certain voltage, the industrial vehicle moves at or near the original velocity and/or direction. Such actuator input parameter tuning is dynamic over time as industrial vehicle performance changes, for example, due to tire degradation.

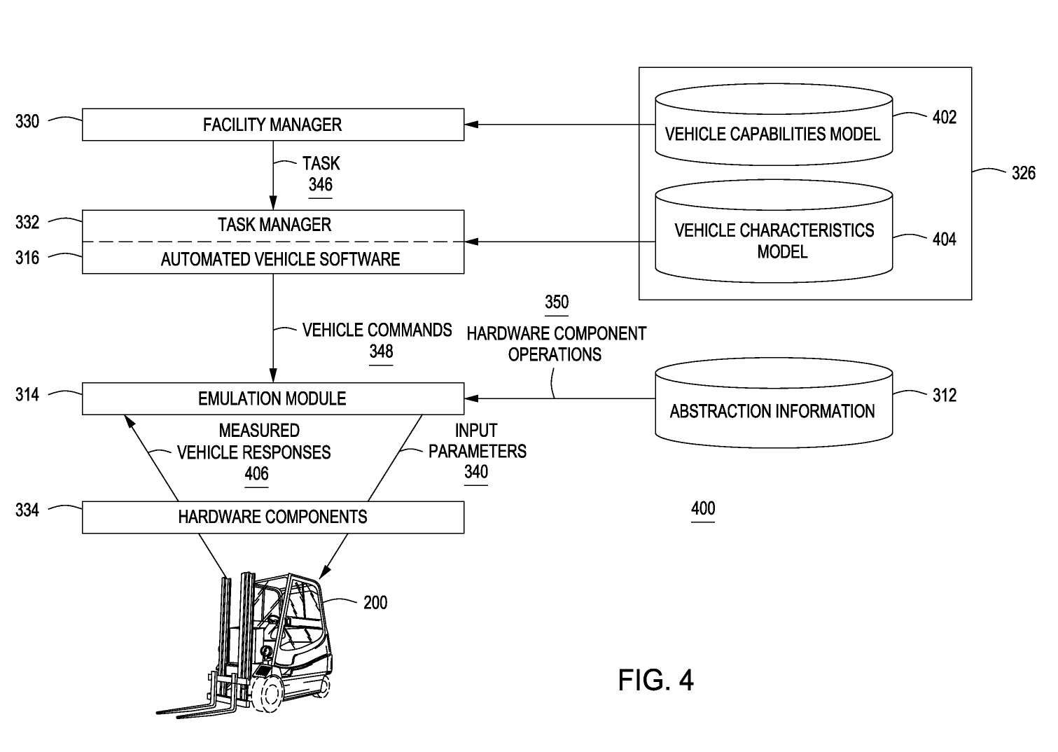

FIG. 4 is a functional block diagram of a system 400 for virtualizing a forklift to emulate hardware component operations and enhance safety within an industrial environment according to one or more embodiments.

In some embodiments, the facility manager 330 performs various optimization functions in support of task automation. The facility manager 330 coordinates execution of a plurality of tasks using a plurality of industrial vehicles. The facility manager 330 communicates the task 346 to the task manager 332. Because the tasks 346 are vehicle-agnostic, the task manager 332 converts the tasks 346 into the vehicle commands 348 (e.g., velocity commands and steering commands) that are dependent upon the industrial vehicle as explained further below. The automated vehicle software 316 receives the vehicle commands 348 from the task manager 332 and calls the emulation module 314 to identify compatible ones of the hardware component operations 350 for the vehicle commands 348 as explained in the present disclosure.

A vehicle capabilities model 402 may represent an abstraction of a particular vehicle, such as a forklift, at a highest level. In some embodiments, the vehicle capability model 402 indicates a maximum velocity, lifting attributes (e.g., a capacity, a maximum height and/or the like), transportation attributes (e.g., narrow aisle, reach, counterbalance and/or the like), mechanical attachments (e.g., barrel clamps and/or the like), fuel attributes (e.g., a type and a capacity) and/or the like.

Similarly, a vehicle characteristics model 404 may represent another level of abstraction for the particular vehicle. The vehicle characteristics model 404 indicates vehicle attachment control attributes to enable object (i.e., product) handling, kinematic models associated with motion control attributes for the industrial vehicle, outline models required for path planning, sensor geometry models required for processing sensor array data (e.g., the sensor array data 338 of FIG. 3).

The vehicle capabilities model 402 and the vehicle characteristics model 404 enable the retrofit automation of industrial vehicles, especially forklifts, in a manner that is essentially agnostic to manufacturer, environment or model. The abstraction information 312 isolates the implementation details from the vehicle commands 348 allowing the vehicle models 326 to represent each and every vehicle using certain attributes.

The facility manager 330 communicates instructions for completing the tasks 346 to the vehicle 200 with the capability of executing the vehicle commands 348 that define these tasks 346. The task manager 332 receives these task and selects an optimal one of the vehicles 200 having similar characteristics to ensure effective management of the physical environment, such as a warehouse or cold store. In one embodiment, the facility manager 330 partitions the tasks 346 into sub-tasks to be performed by different industrial vehicle types. For example, delivery of an object load (e.g., a pallet of products) from a racked storage location in a cold room to a containerization facility may be a combination of the multiple sub-tasks. Then, the facilitate manager 330 selects an appropriate vehicle in a vehicle fleet to execute each sub-task.

Some vehicles are designed for working in racked and blocked stowed cold room environments and thus, are ideally suited to transporting object loads to and from these rooms. However, energy management and vehicle considerations suggest that the optimum vehicle for loading and unloading trucks might be an internal combustion counterbalance lift truck. The vehicle capabilities model 402 indicates capabilities and the facility manager 330 will attempt to use the vehicles most effectively to complete assigned tasks within the warehouse facility. The vehicle capabilities model 402 also includes optimization attributes, such as energy levels, task completion times, vehicle utilization and a number of other factors.

The facility manager 330 uses the vehicle capability model 402 to assign tasks to the vehicle. As an example, the facility manager 330 encounters the simultaneous arrival of two tasks for which two industrial vehicles are available. The task manager 330 optimizes completion of these tasks in a timely and energy efficient manner by, for example, not moving the two vehicles unnecessarily, dividing the two tasks into sub-tasks and ensuring a particular industrial vehicle is capable of performing each activity required for either of the two tasks.

For example, the facility manager 330 selects a counterbalance truck to perform all apron tasks using an interchange zone at an entry point to one or more cold rooms for transferring object loads to cold room trucks. Because transit time between a cold room and the counterbalance truck is critical, the facility manager 330 may select multiple counterbalance trucks and cool room trucks to pick-up or deliver object loads to complete time-critical activities. The cool room truck may also be instructed to perform apron tasks to assist with truck loading if it has an appropriate vehicle capability.

In one embodiment, the vehicle capabilities model 402 enables fleet management and task coordination without requiring every forklift 200 to be equipped with numerous sensors, such as laser scanners and/or cameras. Instead, the facility manager 332 uses a limited number of sensor-equipped vehicles to detect obstructions and generate a map illustrating each and every obstruction in an industrial environment. The obstruction map may be used by any vehicles for path planning.

In one embodiment, the task manager 332 utilizes models based on various characteristics of numerous industrial vehicles such that the tasks 346 are applicable to many vehicle types. Based on data describing vehicle characteristics of a specific industrial vehicle, the task manager 332 determines velocity and steering commands for executing the tasks 346. For example, the tasks 346 rely on the vehicle characteristics model 404 to control the movement of the forklift 200.

The emulation module 314 isolates the automated vehicle software 316 and/or the task manager 332 from details associated with the vehicle hardware components 334 being operated. The emulation module 314 generates the abstraction information 312 to include objects (e.g., primitive data models) for storing such details and enabling manipulation of the industrial vehicle being automated, for a forklift, by the automated vehicle software 316. In some embodiments, the emulation module 314 creates controller objects for the vehicle hardware components 334, such as steering components (e.g., a steering wheel or a joystick), engine control components (e.g., a throttle), braking components, lifting components (e.g., forks), tilt components, side-shift components and/or the like. The emulation module 314 also creates objects for various attachments, such as a reach for a reach truck, a clamp, single/double forks and/or the like. The emulation module 314 further defines these objects with the hardware component operations 350.

Aside from the hardware component operations 350, the emulation module 314 creates abstract objects for a vehicle health including engine temperature, battery levels, fuel levels and/or the like. In addition, a sensor array (e.g., the sensor array 108 of FIG. 1 and FIG. 3) provides information from various vehicle-equipped devices, such as data from load sensors, cameras, laser scanners and/or the like. This information is required for localization, environment sensing and product sensing services in the vehicle automation layer. In order to abstract the vehicle automation layer from details of the hardware the data received from physical sensors is processed by the abstraction layer objects that are used in the higher order processing.

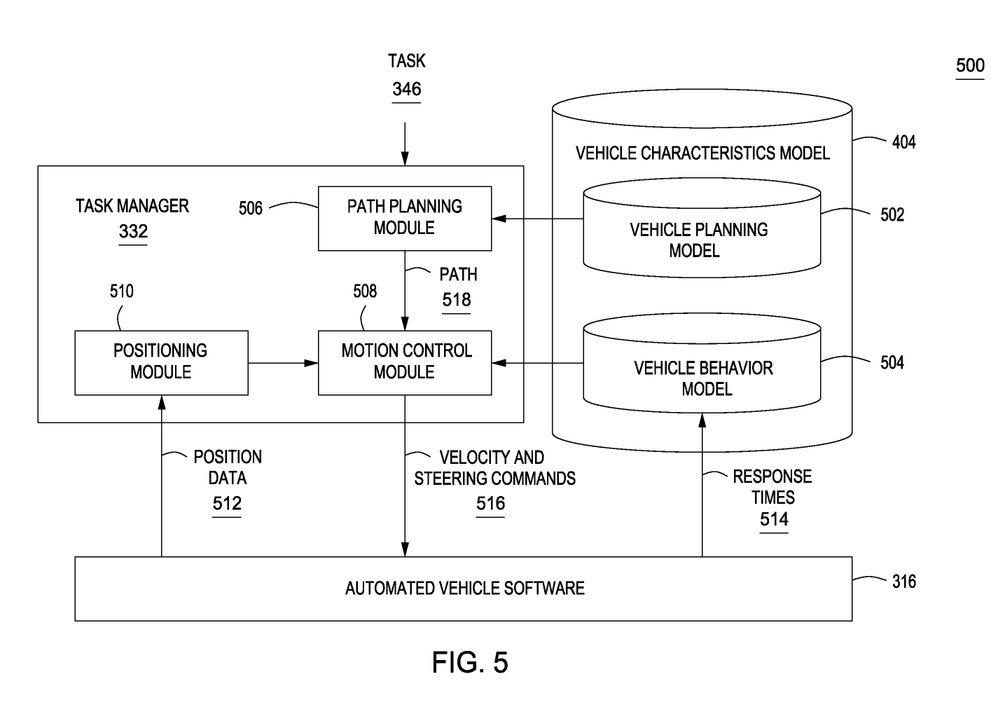

FIG. 5 is a functional block diagram illustrating a system 500 for optimizing task execution using the vehicle characteristics model 404 according to one or more embodiments. The system 500 is exemplary embodiment of a task manger (e.g., the task manager 332 of FIG. 3) interacting with automated vehicle software (e.g., the automated vehicle software 316 of FIG. 3). Using steering and velocity commands with position feedback, the task manager forms the task 346 by combining numerous, individual task steps including fork movements and other activities. Auxiliary functions performing during vehicle movement, such as obstruction detection, also impact task execution.

The system 500 also includes the utilization of a vehicle planning model 502 and a vehicle behavior model 504 to execute various tasks within an industrial environment, such as a factory or warehouse. The task 346 include scripts (e.g., high level software code (i.e., processor-executable instructions)) that generally refer to substantially vehicle independent steps for completing the various operations, such as drive to a location, find a product, pick up an object load (i.e., a product), drive to another location, identify the target drop location and place the object load.

As shown in FIG. 5, the task manager 332 includes various software modules for executing the task 346 using an industrial vehicle, such an automated forklift (e.g., the forklift 200 of FIG. 2). The task manager 332 includes a path planning module 506 for creating a path 518 based the vehicle planning model 502. The task manager 332 also includes a motion control module 508, which uses the vehicle behavior model 504 to determine vehicle commands (e.g., the vehicle commands 348 of FIG. 3) for moving the industrial vehicle along the path 518. The task manager 332 also includes a positioning module 510 that communicates positional data 512 to the motion control module 508. The task manager 332 also optimizes motion control by updating the vehicle behavior model 504 with recent vehicle performance as explained further below.

The vehicle behavior model 504 includes various attributes associated with the industrial vehicle being controlled, such as a maximum acceleration, a maximum deceleration, a maximum velocity around corners and/or other vehicle-dependent attributes. The vehicle behavior model 504 also includes latency attributes associated with vehicle command performance. These latency attributes are continuously updated with response times 514 as the vehicle commands 348 are executed by the automated vehicle software 312. The motion control module 508 can now determine accurate latencies for the vehicle command performance and adjust the vehicle commands accordingly.

The path planning module 506 uses the vehicle planning model 502 to generate vehicle-dependent route data describing a path clear of known obstructions. Based on attributes such as a maximum velocity and a maximum size load, the path planning module 506 determines the path 518 for executing the task 346. The path 518 is communicated to the motion control module 508, which uses the vehicle pose and the vehicle behavior model 504 to generate velocity and steering commands 516. At anytime, the path 518 may be altered because of previously unknown obstructions that are sensed during travel, such as a manually driven forklift, which will result in the industrial vehicle driving around the obstruction, if possible, or the facility manager 330 may select a different industrial vehicle and produce another path that avoids the obstruction to complete the task 346.

The motion control module 508 adjusts the vehicle commands 348 using measured vehicle responses (e.g., the measured vehicle responses 406 of FIG. 4). In some embodiments, the motion control module 508 modifies the vehicle behavior model 504 using the response times 514 and/or variations in attachment control attributes for object handling. The vehicle commands 348 may include abstract vehicle command paradigms, such as the velocity commands and steering commands 516 for moving the industrial vehicle to a target destination and handling the path 518 curvatures. The motion control module 508 also implements vehicle latency models as a portion of the vehicle behavior model 504. The motion control module 508 modifies the attributes for the vehicle latency models based on the response times 514, such that predictable and repeatable vehicle responses are achieved.

The positional module 510 receives positional data 512 from the automated vehicle software 316 in the form of data from sensor array devices, actuators and/or the like. The positional data 512 includes map based information associated with the industrial environment. The positional data 512 may include a fixed position reference that is provided by a positional service, such as a laser positioning system, global positional system (GPS) and/or the like. The positional data 512 may also include odometry data (e.g., the actuator data 342 of FIG. 3) to calculate a position based on dead reckoning. In addition, the positional module 510 may use laser scanner data (e.g., the sensor array data 338 of FIG. 3) to correct the positional data 512.

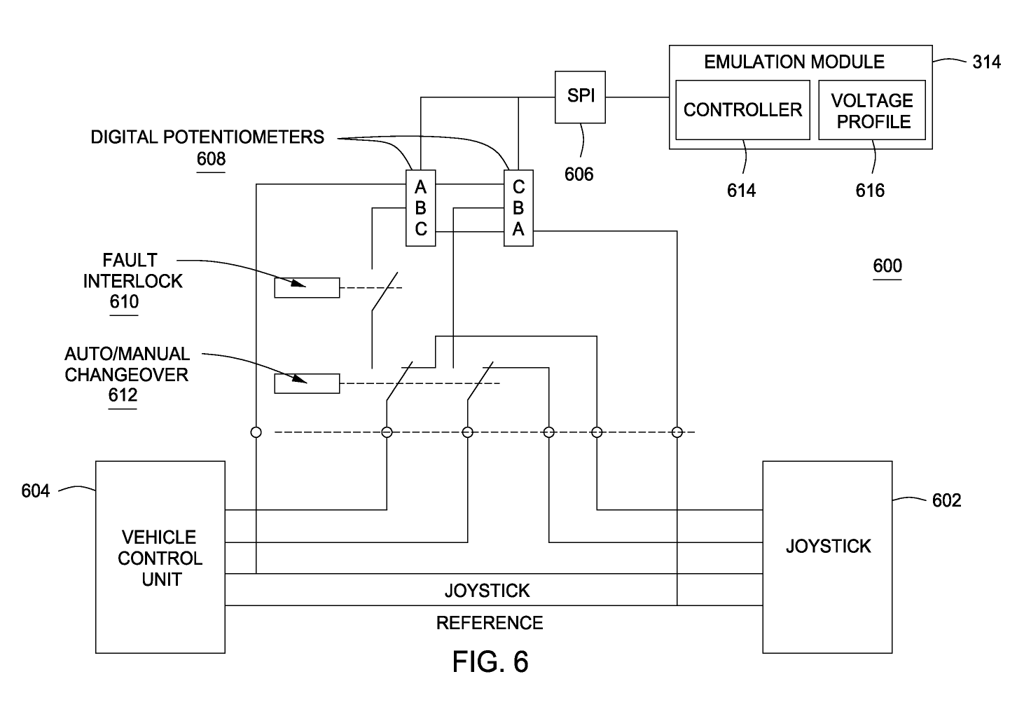

FIG. 6 illustrates a joystick operation emulation circuit 600 according to one or more embodiments. The joystick operation emulation circuit 600 may be a vehicle hardware component that enables motion control over an automated forklift (e.g., the forklift 200 of FIG. 2). Under manual control, the joystick 602 functions as an input device for operating the automated forklift. For example, a human operator may utilize the joystick 602 to control the movement of the automated forklift along a path.

Under automatic control, the operation of the joystick 602 is emulated by a voltages being generated by the emulation module 314 via one or more digital potentiometers 608. The emulation module 314 uses the digital potentiometers 608 to communicate the voltages to a vehicle control unit 604. These voltages may be complementary about a midpoint between a maximum voltage (Reference) and ground according to some embodiments. The emulation module 314 may use a serial peripheral interface (SPI) connection 606 to configure the digital potentiometers 608 with input parameters for controlling operation of the joystick 602. Instead of using input electrical signals from the joystick 602, the vehicle control unit 604 uses the voltages from the digital potentiometers 608 to activate vehicle functions.

In some embodiments, the emulation module 314 includes a voltage profile 616 for emulating the joystick 602. The voltage profile 616 indicates control voltages equivalent to specific joystick 602 movements. For example, one or more control voltages correlate with a center position. The control voltages, therefore, can be used to emulate the joystick 602 being held at the center position. In one embodiment, the control voltages do not precisely correspond with the center position. As such, the control voltages may not be entirely equivalent. The control voltages are stored in the vehicle control unit 604 as a zero point. When automating joystick operation control, the emulation module 314 accounts for such an imprecision using polynomial fitting or piecewise functions.

As shown in FIG. 6, the emulation module 314 is completely disconnected from the industrial vehicle during manual control by, for example, a relay, such as an auto/manual changeover 612. The auto/manual changeover 612 is configured such that a power loss disconnects the emulation module 314, which improves overall safety. During the automatic mode, the emulation module 314 provides complementary voltages to the vehicle control unit 604 through the digital potentiometers 608, which mimic the manual operation of manual joysticks. Finally, a fault interlock 610 configures the joystick operation emulation circuit 600 to indicate a state that will be detected by the vehicle control unit 604 as a fault, such as a power failure. In response, the vehicle control unit 604 freezes industrial vehicle movement as a safety measure.

The emulation module 314 processes current position measurements associated with actuators coupled to the vehicle. The actuator position may be determined by piggy-backing on an existing sensor array device or read from the vehicle control unit 604 over an automation interface, such as CANbus. Alternatively, the actuator position may be directly determined by a measurement device that is coupled a vehicle hardware component, such as a laser range finder to measure the height of forks. Alternatively, a combination of direct measurement and reading of the vehicle control unit 604 may be used where, for instance, the current position measurement only applies for a certain range of movement.

The emulation module 314 includes a controller 614 (e.g., a proportional-integral-derivative (PID) controller) for implementing a control loop feedback mechanism to optimize vehicle command performance. The controller 614 executes the control loop with linearization to maintain the measurement sensitivity over a control range of the joystick operation. In a vehicle automation situation where the underlying behavior of the vehicle may change based on various environment or mechanical factors (e.g., wear) it is important that the controller 614 auto-tune the voltage profile 616.

The emulation module 314 converts a certain vehicle command into one or more meaningful parameters for the controller 614. For example, the emulation module 314 receives a velocity or steering command and accesses a voltage profile 616 indicating specific voltages for emulating operations of the joystick 602. The emulation module 314 identifies one or more voltages for performing the velocity or steering command and communicates these voltages to the controller 614. The controller 614 may adjust the voltages to account for differences between a measured vehicle position and an expected vehicle position. In some embodiments, the measured vehicle position and the expected vehicle position refer to measured and expected actuator positions, respectively. The controller 614 also implements error handling to detect failures of the control and report them to the emulation module 314.

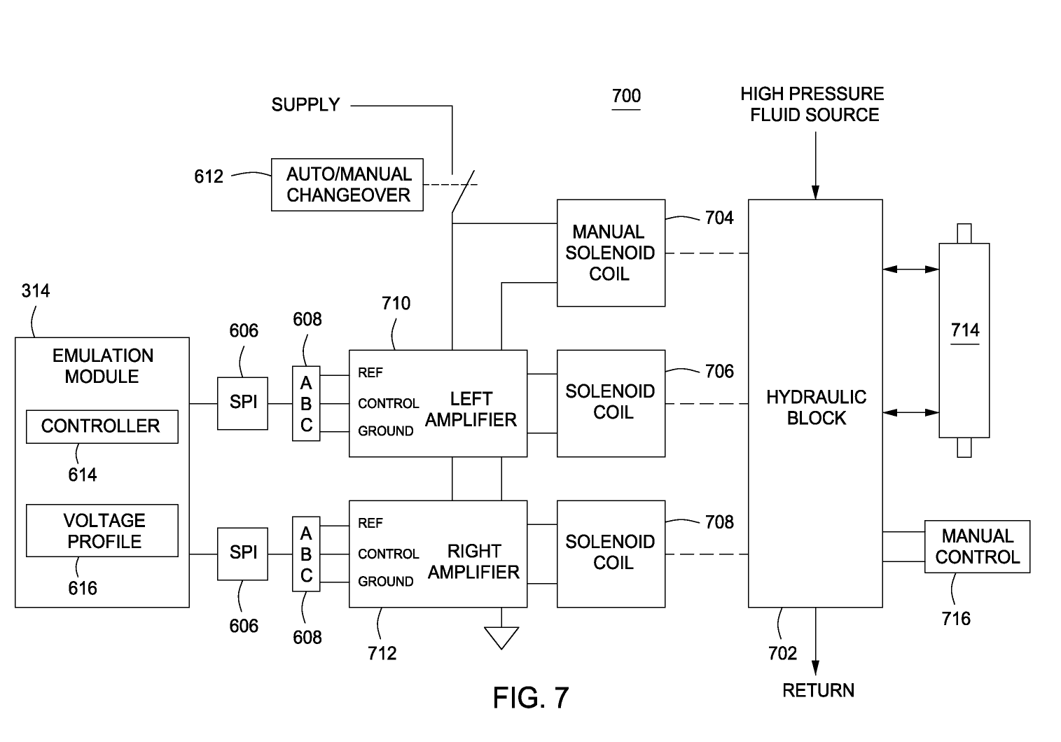

FIG. 7 illustrates a hydraulic component emulation circuit 700 according to one or more embodiments. In one embodiment, the hydraulic component emulation circuit 700 controls steering of an industrial vehicle, such as an automated forklift. In some embodiments, the hydraulic component emulation circuit is used for many forklift functions, such as control over fork height, tilt and/or side-shift.

The emulation module 314 uses the voltage profile 616 to configure the digital potentiometers 608 and control operations of a hydraulic ram 714 according to various embodiments. In a manner similar to the joystick operation emulation as described for FIG. 6, the emulation module 314 uses the controller 614 to calibrate the voltages in the voltage profile 616. The auto/manual changeover 612 is an on-off control switch that is configured so that a manual solenoid coil 704, a solenoid coil 706 and/or a solenoid coil 704 are energized in preparation of task execution. The manual solenoid coil 704 redirects the internal fluid paths within the hydraulic block 702 such that manual control 716 no longer controls the flow of hydraulic fluid to the hydraulic ram 714. A power failure causes the hydraulic component control revert to back to the manual control 716.

In an automatic mode, hydraulic fluid pressure is provided to a proportional valve within a hydraulic control block 702. The proportional valve uses the solenoid coil 706 and the solenoid coil 708 to change both a direction and flow rate to the hydraulic control block 702. The current in the solenoid is set using a left amplifier 710 and a right amplifier 712, which permit the emulation module 314 to manipulate both the direction and rate at which the hydraulic fluid moves to the hydraulic ram 714. Then, the digital potentiometers 608 derive the control voltages for the left amplifier 710 or the right amplifier 712.

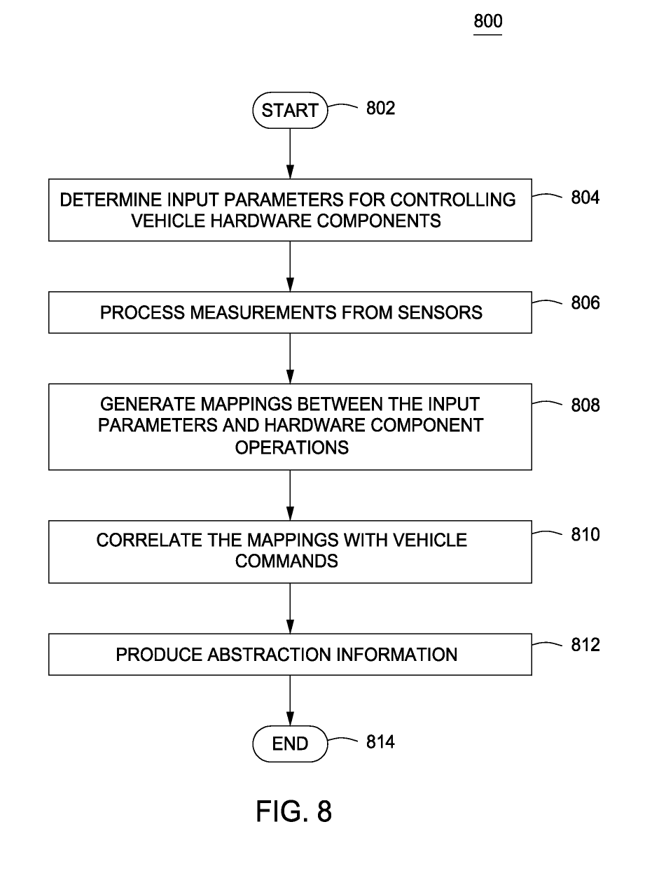

FIG. 8 is a flow diagram of a method 800 for automating industrial vehicles in a physical environment according to one or more embodiments. The method 800 may be performed by an emulation module (e.g., the emulation module 314 of FIG. 3) within a computer (e.g., the mobile computer 106 of FIG. 1).

The method 800 starts at step 802 and proceeds to step 804. At step 804, input parameters for controlling vehicle hardware components are determined. In some embodiments, the emulation module applies a particular input parameter to one of the vehicle hardware components resulting in a corresponding hardware component operation. The emulation module compares an expected vehicle response for the certain hardware component operation with a measured vehicle response. As explained in the present disclosure, the measured vehicle response includes various measurements provided by an actuator and/or a laser scanner. The expected vehicle response may include positional measurements associated with previous hardware component operations. Alternatively, the expected vehicle response may be defined in terms of a received vehicle command. If these measurements deviate from the expected vehicle response, the emulation module adjusts the particular input parameter.

At step 806, measurements from various sensors are processed. In some embodiments, these sensors include various external sensor devices that are retrofitted on the industrial vehicle where needed. For example, the industrial vehicle is retrofitted with a sensor for measuring fork height or determining an on-vehicle sensor reading method, such as CAN or an analogue value. At step 808, mappings are generated between the input parameters and hardware component operations. In some embodiments, when the emulation module determines a value (e.g., a voltage) for the particular input parameter that achieves the expected vehicle response, a mapping between the particular input parameter and the certain hardware component operation is stored in configuration information. For example, the configuration information may include a voltage profile comprising voltages for activating and controlling various hardware component operations, such as joystick operations.

At step 810, the mappings are correlated with vehicle commands. In some embodiments, the emulation module identifies relationships between the hardware component operations and the vehicle commands. In one embodiment, the emulation module examines the configuration information and identifies compatible ones of the hardware component operations for performing the vehicle commands. The compatible hardware component operations may be based on the expected vehicle response. For example, the emulation module may determine one or more emulated joystick operations that result in vehicle movement substantially similar to one or more velocity and steering commands (e.g., the velocity and steering commands 516 of FIG. 5). At step 812, the abstraction information is produced. In some embodiments, the abstraction information indicates compatible joystick operations for the vehicle and steering commands. At step 814, the method 800 ends.

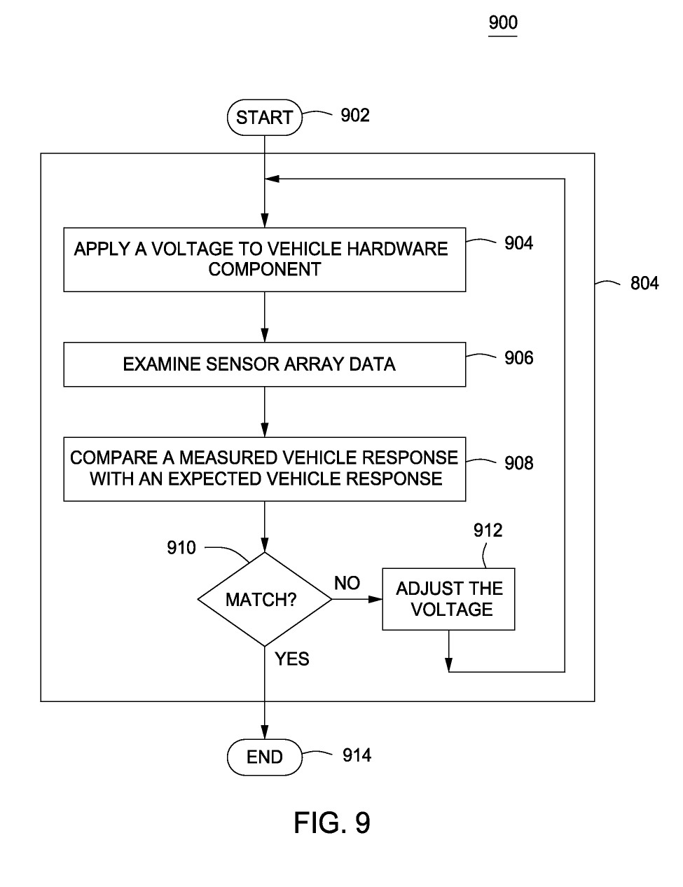

FIG. 9 is a flow diagram of a method 900 for calibrating the input parameters based on vehicle responses according to one or more embodiments. The method 900 illustrates one or more embodiments of the step 804 as depicted in FIG. 8. The method 900 may be performed by an emulation module (e.g., the emulation module 314 of FIG. 3).

The method 900 starts at step 902 and proceeds to step 904. At step 904, a voltage is applied to a vehicle hardware component. For example, the voltage is communicated to a joystick via one or more digital potentiometers and used to achieve a specific joystick operation. The voltage application may result in joystick movement at a particular direction and magnitude causing the vehicle to move along a path curvature at a certain velocity. In some embodiments, the emulation module configures one or more digital potentiometers (e.g., the digital potentiometers 608 of FIG. 6) with a value representing the voltage. The digital potentiometers generate the voltage, which is communicated to a vehicle control unit in order to perform a corresponding hardware component operation.

At step 906, sensor array data is examined. In some embodiments, the voltage is applied to one or more actuators that control performance of the corresponding hardware component operation. From the sensor array data, the emulation module extracts positional measurements (e.g., the positional data 512 of FIG. 5) for the one or more actuators and determines a measured vehicle response to the voltage. At step 908, the measured vehicle response is compared with an expected vehicle response. In one embodiment, the emulation module compares the positional measurements with expected positional measurements.

At step 910, a determination is made as to whether the measured vehicle response matches the expected vehicle response. If the measured vehicle response deviates from the expected vehicle response, the method 900 proceeds to step 912. At step 912, the voltage is adjusted. In one embodiment, the abstraction information updates the expected vehicle response with the positional measurements. After step 912, the method 900 returns to step 904. The method 900 is repeated in order to calibrate the voltage. If, on the other hand, the measured vehicle response matches from the expected vehicle response, the method 900 proceeds to step 914. At step 914, the method 900 ends.

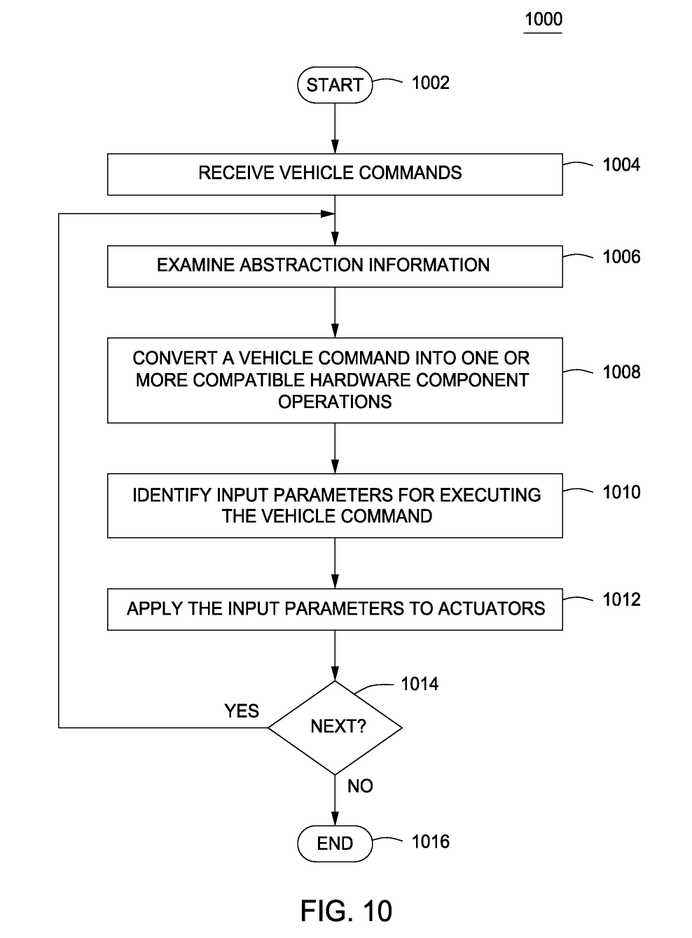

FIG. 10 is a flow diagram of a method 1000 for executing a task using abstraction information according to one or more embodiments. The method 1000 may be performed by an emulation module (e.g., the emulation 314 of FIG. 3).

The method 1000 starts at step 1002 and proceeds to step 1004. At step 1004, one or more vehicle commands are received. In one embodiment, a task manager (e.g., the task manager 332 of FIG. 3) communicates the one or more vehicle commands (e.g., the velocity and steering commands 516 of FIG. 5) to automated vehicle software (e.g., the automated vehicle software 316 of FIG. 3). These vehicle commands form at least a portion of the task (e.g., the task 346 of FIG. 3). The automated vehicle software, in turn, calls processor-executable instructions for the emulation module from memory. Then, the automated vehicle software instructs the emulation module to execute the one or more vehicle commands.

At step 1006, abstraction information is examined. In one embodiment, the emulation module accesses the abstraction information (e.g., the abstraction information 312 of FIG. 3) to identify hardware component operations (e.g., the hardware component operations 350 of FIG. 3) that are compatible with the received vehicle commands. At step 1008, a vehicle command is converted into one or more compatible hardware component operations. At step 1010, input parameters for performing the compatible hardware operations are identified. In one embodiment, the emulation module identifies the input parameters (e.g., control voltages) that map to the one or more compatible hardware component operations.

At step, 1012, the input parameters are applied to actuators. For example, the input parameters may refer to voltages that control the performance of the compatible hardware component operations. In one embodiment, the emulation module applies such voltages to a vehicle hardware component using digital potentiometers. The vehicle hardware component, subsequently, performs the compatible hardware component operations and generates a measured vehicle response. In some embodiments, the emulation module compares the measured vehicle response with the vehicle command. If the measured vehicle response differs from the vehicle command, the emulation module adjusts the input parameters. Otherwise, the emulation module leaves the input parameters unchanged and proceeds to step 1014.

At step 1014, a determination is made as to whether there are more vehicle commands. If there is a next vehicle command, then the method 1000 returns to step 1006. The emulation module proceeds to use the abstraction information to execute the next vehicle command in the task. If, on the other hand, it is determined that there are no more vehicle commands, the method 1000 proceeds to step 1016. At step 1016, the method 1000 ends. For different vehicle commands, the method 1000 may execute in parallel.

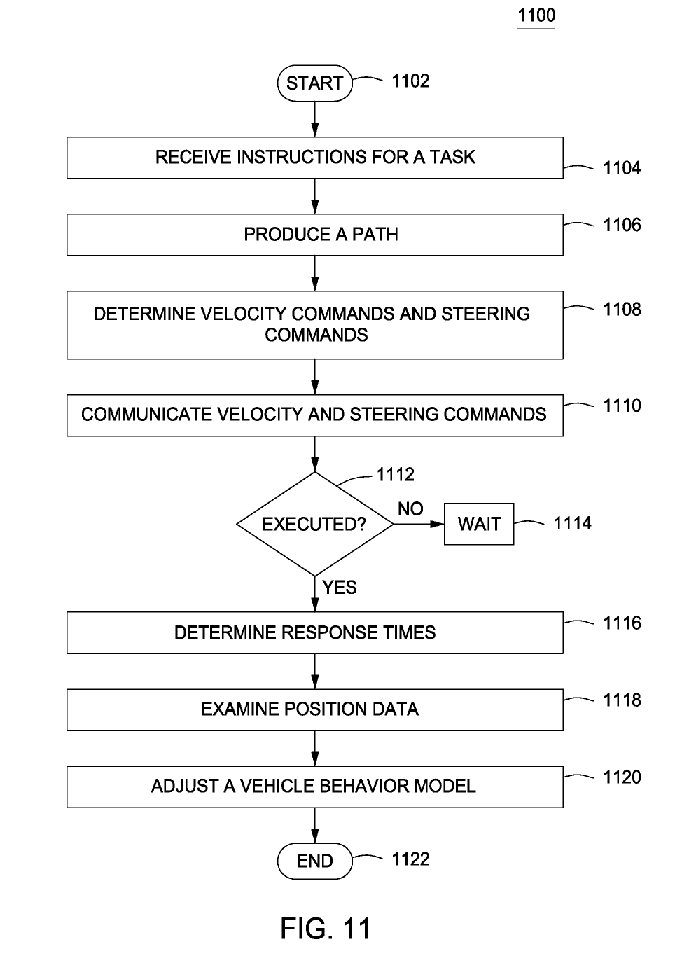

FIG. 11 is a flow diagram of an exemplary method 1100 for converting a task into velocity commands and steering commands according to one or more embodiments. The method 1100 may be performed by a task manager (e.g., the task manager 332 of FIG. 3). Furthermore, performing the task involves controlling actuators in ways other than steering and velocity. While driving an industrial vehicle, sensor array devices (e.g., the device 318 of the sensor array 108 of FIG. 3) are scanning a physical environment and updating facility information (e.g., the facility information 328 of FIG. 3) according to some embodiments. For example, the facility information may be updated with positions of various objects, such as obstructions and goods.

The method 1100 starts at step 1102. At step 1104, a task is received. In one embodiment, a facility manager (e.g., the facility manager 330 of FIG. 3) creates the task (e.g., the task 346 of FIG. 3) using vehicle-independent instructions or steps. The task manager 332 converts the vehicle-independent steps into various vehicle commands (e.g., the vehicle commands 348 of FIG. 3). At step 1106, a path is produced. In one embodiment, the task manager utilizes a path planning model (e.g., the path planning model 502 of FIG. 5) to generate the path for performing the task. At step 1108, velocity commands and steering commands are determined. In order to move a vehicle along the path, the task manager converts the task into one or more velocity and steering commands (e.g., the velocity and steering commands 516 of FIG. 5). At step 1110, the velocity commands and the steering commands are communicated to the vehicle.

At step 1112, a determination is made as to whether the vehicle executed the velocity commands and the steering commands. If these commands have not executed, the method 1100 proceeds to step 1114. At step 1114, the method 1100 waits for information indicating that the vehicle executed the velocity commands and the steering commands. In one embodiment, the task manager receives positional data (e.g., the positional data 512 of FIG. 5) indicating vehicle movement. After these vehicle commands are executed, the method 1110 proceeds to step 1116.

At step 1116, response times for executing the velocity commands and the steering commands are processed. At step 1118, the positional data associated with the vehicle movement is examined. At step 1120, a vehicle behavior model is adjusted. In one embodiment, the emulation module modifies the vehicle behavior model (e.g., the vehicle behavior model 504 of FIG. 5) with updated vehicle latency attributes associated with the velocity and steering commands. At step 1122, the method 1100 ends.

While the foregoing is directed to embodiments of the present invention, other and further embodiments of the invention may be devised without departing from the basic scope thereof, and the scope thereof is determined by the claims that follow.

1. A method of virtualizing industrial vehicles to automate task execution in a physical environment, comprising:
determining input parameters for controlling vehicle hardware components, wherein the vehicle hardware components comprise actuators that are used to control hardware component operations;
generating mappings between the input parameters and the hardware component operations, wherein each of the input parameters is applied to an actuator to perform an corresponding hardware component operation;
correlating the mappings with vehicle commands to produce abstraction information; and
executing at least one task comprising various ones of the vehicle commands using the abstraction information.

2. The method of claim 1, wherein executing the at least one task further comprises adjusting the input parameters based on measured vehicle responses associated with the task instruction execution.

3. The method of claim 2, wherein adjusting the input parameters based on measured vehicle responses further comprises modifying a vehicle behavior model using updated vehicle latency attributes associated with at least one of velocity commands or steering commands.

4. The method of claim 1, wherein executing the at least one task further comprises converting the task into at least one compatible hardware component operation that is performed in the industrial vehicle.

5. The method of claim 1, wherein determining the input parameters further comprises combining multiple laser scans of the physical environment to create a single laser scan.

6. The method of claim 1, wherein determining the input parameters further comprises comparing an expected vehicle response with a measured vehicle response to determine a voltage for performing at least one of the hardware component operations.

7. The method of claim 1, wherein determining the input parameters further comprising:
applying a voltage to at least one of the vehicle hardware components;
examining sensor array data associated with vehicle movement;
comparing the sensor array data with an expected vehicle response; and
adjusting the voltage based on the comparing step.

8. The method of claim 7 repeating the applying step, the examining step, the comparing step and the adjusting step to calibrate the voltage.

9. The method of claim 1, wherein executing the at least one task further comprising:
identifying compatible hardware component operations for performing the various ones of the vehicle commands; and
communicating at least one of the input parameters associated with the compatible component operations to at least one corresponding hardware component.

10. The method of claim 1, wherein executing the at least one task further comprises freezing industrial vehicle movement and switching industrial vehicle control to manual mode in response to a power failure.

11. A computer-readable-storage medium comprising one or more processor-executable instructions that, when executed by at least one processor, causes the at least one processor to:
determine input parameters for controlling vehicle hardware components, wherein the vehicle hardware components comprise actuators that are used to control hardware component operations;
generate mappings between the input parameters and the hardware component operations, wherein each of the input parameters is applied to an actuator to perform an corresponding hardware component operation; and
correlate the mappings with vehicle commands to produce abstraction information, wherein the abstraction information is used to execute at least one task comprising various ones of the vehicle commands.

12. The computer-readable-storage medium of claim 11 further comprising one or more processor-executable instructions that, when executed by the at least one processor, causes the at least one processor to:
apply a voltage to at least one of the vehicle hardware components;
examine sensor array data associated with vehicle movement; and
compare the sensor array data with an expected vehicle response to adjust the voltage.

13. The computer-readable-storage medium of claim 11 further comprising one or more processor-executable instructions that, when executed by the at least one processor, causes the at least one processor to:
compare an expected vehicle response with a measured vehicle response to determining a voltage for performing at least one of the hardware component operations.

14. The computer-readable-storage medium of claim 11 further comprising one or more processor-executable instructions that, when executed by the at least one processor, causes the at least one processor to:
convert the various ones of the vehicle commands into at least one compatible hardware component operation that is performed in the industrial vehicle

15. An apparatus for virtualizing industrial vehicles to automate task execution in a physical environment, comprising:
a computer for emulating vehicle hardware component operations, comprising:
an emulation module for determining input parameters for controlling vehicle hardware components, wherein the vehicle hardware components comprise actuators that are used to control hardware component operations, generating mappings between the input parameters and the hardware component operations, wherein each of the input parameters is applied to an actuator to perform an corresponding hardware component operation, correlating the mappings with vehicle commands to produce abstraction information, wherein the vehicle commands are defined in terms of attributes associated with the vehicle hardware components, using the abstraction information to execute at least one task comprising various ones of the vehicle commands.

16. The apparatus of claim 15, wherein the emulation module processes sensor array data to determine a voltage profile associated with emulating the hardware component operations.

17. The apparatus of claim 15 further comprising a task manager for determining a path for executing the at least one task and communicating velocity commands and steering commands for the path to the industrial vehicle, wherein the velocity commands and the steering commands correspond with the industrial vehicle.

18. The apparatus of claim 17, wherein the other task manager selects the industrial vehicle based on vehicle capabilities.

19. The apparatus of claim 17, wherein the emulation module converts the velocity commands and steering commands into at least one compatible hardware component operation that is performed in the industrial vehicle.

20. The apparatus of claim 15, wherein the computer is configured to couple with an industrial vehicle and receive the at least one task from another computer.
